(19) United States
(12) Patent Application Publication
(10) Pub. No.: US 2026/0291589 A1
(43) Pub. Date: Sep. 24, 2026

(54) SIDELINK TRANSMISSION AND RECEPTION BEAMS FOR BEAM MANAGEMENT

(71) Applicant: Apple Inc., Cupertino, CA (US)

(72) Inventors: Chunxuan Ye, San Diego, CA (US); Dawei Zhang, Saratoga, CA (US); Haitong Sun, Saratoga, CA (US); Hong He, San Jose, CA (US); Huaning Niu, San Jose, CA (US); Wei Zeng, Saratoga, CA (US)

(21) Appl. No.: 19/472,394

(22) PCT Filed: Apr. 4, 2024
(86) PCT No.: PCT/US2024/023085

§ 371 Date: Oct. 3, 2025

Related U.S. Application Data
(60) Provisional application No. 63/457,904, filed on Apr. 7, 2023.

(51) Int. Cl. H04B 7/06; H04L 5/00

(52) U.S. Cl. CPC H04B 7/06954; H04B 7/0626; H04L 5/0007; H04L 5/005; H04L 5/0092

(57) ABSTRACT

Disclosed are methods, user devices, processors configured to perform operations including receiving, from a receiver (Rx) user equipment (UE) via a sidelink interface, a beam switching time of the Rx UE; configuring one or more resources for transmitting one or more sidelink channel state information reference signals (CSI-RS) to the Rx UE, where a maximum number of sidelink CSI-RS symbols for transmission in a slot is determined based on the beam switching time of the Rx UE; and causing transmission to the Rx UE: of (i) an indication of a selected number of sidelink CSI-RS symbols in the slot, where the selected number of sidelink CSI-RS symbols is less than or equal to the maximum number of sidelink CSI-RS symbols, and (ii) the one or more sidelink CSI-RS using the one or more resources.

This application claims priority to 63/457,904, filed on Apr. 7, 2023, which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

One aspect of the subject matter described in this specification may be embodied in a method that involves receiving, from a receiver (Rx) user equipment (UE) via a sidelink interface, a beam switching time of the Rx UE; configuring one or more resources for transmitting one or more sidelink channel state information reference signals (CSI-RS) to the Rx UE, where a maximum number of sidelink CSI-RS symbols for transmission in a slot is determined based on the beam switching time of the Rx UE; and transmitting to the Rx UE: (i) an indication of a selected number of sidelink CSI-RS symbols in the slot, where the selected number of sidelink CSI-RS symbols is less than or equal to the maximum number of sidelink CSI-RS symbols, and (ii) the one or more sidelink CSI-RS using the one or more resources.

The previously described implementation is implementable using a method; a non-transitory, computer-readable medium storing computer-readable instructions to perform the method; one or more processors configured to perform the method; a user equipment (UE) including processing circuitry configured to cause the UE to perform the method; a computer memory interoperably coupled with a hardware processor configured to perform the method or the instructions stored on the non-transitory, computer-readable medium. These and other embodiments may each optionally include one or more of the following features.

In some implementations, the beam switching time of the Rx UE is a number of beam-switching operations that the Rx UE is capable of performing in the slot.

In some implementations, the number of beam-switching operations is based on a subcarrier spacing (SCS) of the sidelink interface.

In some implementations, transmitting to the Rx UE the actual number of sidelink CSI-RS symbols in the slot involves transmitting the actual number of sidelink CSI-RS symbols in a sidelink control information (SCI) message.

In some implementations, the SCI message further includes a resource index of the one or more sidelink CSI-RS.

In some implementations, the actual number of sidelink CSI-RS symbols in the slot is less than or equal to the maximum number of sidelink CSI-RS symbols.

In some implementations, a location of the sidelink CSI-RS symbols in the slot is determined based on the actual number of sidelink CSI-RS symbols.

In some implementations, the slot further includes one or more Physical Sidelink Control Channel (PSCCH) symbols preceding the sidelink CSI-RS symbols.

In some implementations, the slot further includes a minimum gap between a last symbol of PSCCH and a first sidelink CSI-RS symbol.

Another aspect of the subject matter described in this specification may be embodied in a method that involves transmitting, to a transmitter (Tx) user equipment (UE) via a sidelink interface, a beam switching time for a receiver (Rx) UE; configuring one or more resources for receiving from the Tx UE one or more sidelink channel state information reference signals (CSI-RS), wherein a maximum number of sidelink CSI-RS symbols in a slot is determined based on the beam switching time of the Rx UE; receiving, from the Tx UE via the sidelink interface, a selected number of the sidelink CSI-RS symbols in the slot; identifying the sidelink CSI-RS symbols in the slot based on the selected number of sidelink CSI-RS symbols; and using one or more Rx beams for performing beam measurement on the sidelink CSI-RS symbols.

The previously described implementation is implementable using a method; a non-transitory, computer-readable medium storing computer-readable instructions to perform the method; one or more processors configured to perform the method; a user equipment (UE) including processing circuitry configured to cause the UE to perform the method; a computer memory interoperably coupled with a hardware processor configured to perform the method or the instructions stored on the non-transitory, computer-readable medium. These and other embodiments may each optionally include one or more of the following features.

In some implementations, the beam switching time of the Rx UE is a number of beam-switching operations that the Rx UE is capable of performing in the slot.

In some implementations, the number of beam-switching operations is based on a subcarrier spacing (SCS) of the sidelink interface.

In some implementations, receiving, from the Tx UE via the sidelink interface, the actual number of the sidelink CSI-RS symbols in the slot involves receiving the actual number of sidelink CSI-RS symbols in a sidelink control information (SCI) message.

In some implementations, the SCI message further includes a resource index of the one or more sidelink CSI-RS.

In some implementations, identifying the sidelink CSI-RS symbols in the slot is based on the resource index of the one or more sidelink CSI-RS.

In some implementations, the actual number of sidelink CSI-RS symbols in the slot is less than or equal to the maximum number of sidelink CSI-RS symbols.

In some implementations, identifying the sidelink CSI-RS symbols involves determining a location of the sidelink CSI-RS symbols in the slot based on the actual number of sidelink CSI-RS symbols.

In some implementations, the slot further includes one or more Physical Sidelink Control Channel (PSCCH) symbols preceding the sidelink CSI-RS symbols.

In some implementations, the slot further includes a minimum gap between a last symbol of PSCCH and a first sidelink CSI-RS symbol.

Another aspect of the subject matter described in this specification may be embodied in a method to be performed by a receiver (Rx) user equipment (UE) that communicates with one or more transmitter (Tx) UEs on a sidelink interface via one or more Rx beams. The method involves determining a reception operation to be performed by the Rx UE in a slot; selecting, based on the reception operation, at least one Rx beam with which to perform the reception operation in the slot; and performing the reception operation in the slot using the at least one Rx beam.

The previously described implementation is implementable using a method; a non-transitory, computer-readable medium storing computer-readable instructions to perform the method; one or more processors configured to perform the method; a user equipment (UE) including processing circuitry configured to cause the UE to perform the method; a computer memory interoperably coupled with a hardware processor configured to perform the method or the instructions stored on the non-transitory, computer-readable medium. These and other embodiments may each optionally include one or more of the following features.

In some implementations, determining the reception operation to be performed by the Rx UE in the slot involves determining that the reception operation is data reception from a first Tx UE.

In some implementations, selecting, based on the reception operation, at least one Rx beam with which to perform the reception operation in the slot involves selecting a first Rx beam that is associated with Tx beam between the Rx UE and the first Tx UE.

In some implementations, determining the reception operation to be performed by the Rx UE in the slot involves determining that the reception operation is respective data reception from a first Tx UE and a second Tx UE.

In some implementations, selecting, based on the reception operation, at least one Rx beam with which to perform the reception operation in the slot involves determining that the respective data reception from the first Tx UE has a higher priority than the respective data reception from the second Tx UE; and responsively selecting a first Rx beam between the Rx UE and the first Tx UE for performing the respective data reception from the first Tx UE.

In some implementations, determining the reception operation to be performed by the Rx UE in the slot involves determining that the reception operation is measurement of a beam measurement signal from a first Tx UE.

In some implementations, selecting, based on the reception operation, at least one Rx beam with which to perform the reception operation in the slot involves for one or more symbols in the slot that do not include the beam measurement signal, selecting a first Rx beam that is associated with Tx beam between the Rx UE and the first Tx UE; and for one or more symbols in the slot that include the beam measurement signal, selecting one or more scheduled Rx beams for the measurement.

In some implementations, determining the reception operation to be performed by the Rx UE in the slot involves determining that the reception operation comprises measurement of a beam measurement signal from a first Tx UE and data reception from a second Tx UE.

In some implementations, selecting, based on the reception operation, at least one Rx beam with which to perform the reception operation in the slot involves selecting a first scheduled Rx beam for the measurement; or selecting a second scheduled Rx beam for data reception.

In some implementations, selecting between the first scheduled Rx beam and the second scheduled Rx beam is based on a resource pool configuration or pre-configuration, or a priority of the data reception.

In some implementations, determining the reception operation to be performed by the Rx UE in the slot involves determining that the reception operation comprises a sensing operation.

In some implementations, selecting, based on the reception operation, at least one Rx beam with which to perform the reception operation in the slot involves selecting an omni-directional Rx beam; or selecting a preconfigured Rx beam.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE FIGURES

FIG. 1 illustrates an example communication system that includes sidelink communications, according to some implementations.

FIG. 2A and FIG. 2B illustrate a sidelink Rx beam refinement procedure, according to some implementations.

FIG. 3A and FIG. 3B illustrate an example Rx sidelink beam refinement procedure, according to some implementations.

FIG. 4A illustrates an example scenario for applying sidelink Rx beam determination procedures, according to some implementations.

FIG. 4B illustrates an example of sidelink Rx beam selection, according to some implementations.

FIG. 5A, FIG. 5B, and FIG. 5C each illustrate a flowchart of an example method, according to some implementations.

FIG. 6 illustrates an example user equipment (UE), according to some implementations.

FIG. 7 illustrates an example access node, according to some implementations.

### DETAILED DESCRIPTION

Recently, the wireless communication industry, e.g., in Third Generation Partnership Project (3GPP) technical proposals, has begun developing solutions for sidelink beam management. These solutions include sidelink initial beam-pairing, beam maintenance, and beam failure recovery solutions. One solution that has been introduced for beam maintenance is a sidelink Channel State Information (CSI) Reference Signal (CSI-RS) framework. In the proposed framework, CSI acquisition is performed aperiodically on a unicast link between a transmitter (Tx) user equipment (UE) and a receiver (Rx) UE.

This disclosure describes methods and systems for sidelink beam management that provide solutions to issues that are not currently addressed by existing technical proposals. More specifically, this disclosure describes methods and systems for selection of transmission beams and/or receiver beams for beam management messages. Currently, the existing technical proposals do not specify the beams to use for such messages. Additionally, this disclosure describes methods and systems for Rx beam refinement on a sidelink interface. These methods and systems enable a UE to provide an indication of its beam switching time to another UE. Further, this disclosure describes methods and systems for selecting Rx beams on a sidelink interface in various scenarios, e.g., when an Rx UE has overlapping data reception and/or beam measurement on different Rx beams.

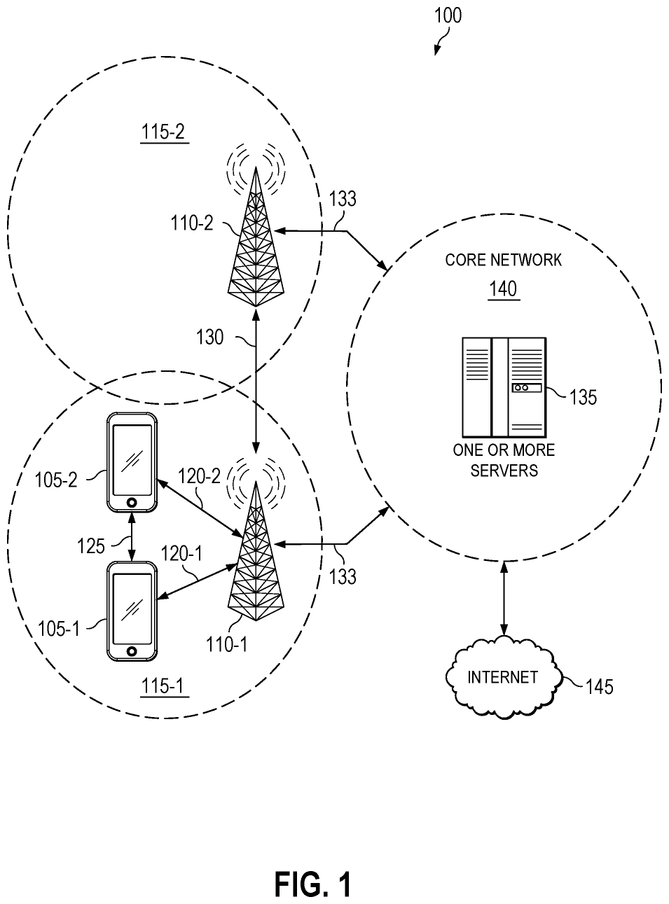

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi networks, and the like. Furthermore, other types of communication standards are possible, including future 3GPP systems (e.g., Sixth Generation (6G)) or the like. While aspects may be described herein using terminology commonly associated with 5G NR, aspects of the present disclosure can be applied to other systems, such as 3G, 4G, and/or systems subsequent to 5G (e.g., 6G).

Frequency bands for 5G NR may be separated into two different frequency ranges. Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR 2) may include frequency bands from 24.25 GHz to 52.6 GHz. Bands in the millimeter wave (mmWave) range of FR2 may have smaller coverage but potentially higher available bandwidth than bands in the FR1.

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communication protocols, such as a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may be “configured” with the parameters from the one or more of the base stations 110. In this disclosure, “(pre)configured” means that “pre-configuration” and “configuration” are both possible.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V 2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and roadside units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool defines the time-frequency resources used for sidelink communications, and may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, a UE that is initiating a communication with another UE is referred to as a transmitter UE (TX UE), and the UE receiving the communication is referred to as a receiver UE (RX UE). For example, UE 105-1 may be a TX UE and UE 105-2 may be an RX UE. Although FIG. 1 illustrates a single TX UE communicating with a single RX UE, a TX UE may communicate with more than one RX UE via sidelink.

In some implementations, a TX UE that is initiating sidelink communication may determine the available resources (e.g., sidelink resources) and may select a subset of these resources to communicate with an RX UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the TX UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the sidelink 125 is established through an initial beam pairing procedure. In this procedure, the UEs 105 identify (e.g., using a beam selection procedure) one or more candidate beam pairs that could be used for the sidelink 125. A beam pair includes a Tx beam between a Tx UE (e.g., UE 105-1) and an Rx UE (e.g., UE 105-2) and an Rx beam between the Tx UE and the Rx UE. The UEs 105 can identify a beam pair by an index, e.g., “Beam Pair #1,” and each beam by its own index, e.g., “Rx Beam #1.”

The UEs 105 are configured to select one of the candidate beam pairs as an initial serving beam pair. The Tx UE can use a Tx serving beam to transmit a signal that is received via the Rx serving beam of the Rx UE. Note that if there is beam correspondence in the beam pair, then the beam pair used for one direction of a data transmission can be applied for the reverse direction of the data transmission. Thus, under conditions in which beam correspondence applies, a beam that is used by UE 105-1 as a Tx beam when the UE 105-1 is a Tx UE can be used as a Rx beam when the UE 105-1 is an Rx UE, and a beam that is used by UE 105-2 as an Rx beam when the UE 105-2 is an Rx UE can be used as a Tx beam when the UE 105-2 is a Tx UE.

In some implementations, the UEs 105 are configured with one or more options for selecting a Tx beam and an Rx beam for beam management messages. In particular, a Tx UE is configured to select a Tx beam and an Rx UE is configured to select an Rx beam for exchanging beam management messages. In some examples, the UEs 105 are configured with one or more options for selecting beams for an initial beam pairing procedure and/or one or more options for selecting beams for a beam maintenance procedure. For both procedures, the UEs 105 are configured with one or more options for selecting the beams for messages from the Tx UE to the Rx UE (Tx UE-Rx UE messages) and/or one or more options for selecting the beams for messages from the Rx UE to the Tx UE (Rx UE-Tx UE messages).

In some implementations, the UEs 105 can transmit the beam management messages in a dedicated slot in a resource pool. Alternatively, the UEs 105 can transmit and/or multiplex the beam management messages, perhaps using frequency division multiplexing (FDM), with a sidelink synchronization signal block (S-SSB).

In some implementations, the UEs 105 are configured with one or more options for selecting the beams for Tx UE-Rx UE messages in an initial beam pairing procedure. The Tx UE-Rx UE messages in an initial beam pairing procedure include a beam management configuration message, an initial beam pairing request message, a beam reporting request message, and/or a beam indication message. In a first option, the UEs 105 are configured to select an omni-directional Tx beam and an omni-directional Rx beam. In a second option, the UEs 105 are configured to use a specific Tx beam and a specific Rx beam. In this option, the beam pair can be configured in a beam management configuration message or by resource pool (pre)configuration. In a third option, the Tx UE is configured to use multiple Tx beams in different directions. These Tx beams may be configured in a beam management configuration message or by resource pool (pre)configuration. In this option, the Rx beam is based on the Rx UE's implementation (e.g., a specific Rx beam or an omni-directional Rx beam). Note that the UEs 105 can be configured to use different options for different Tx UE-Rx UE messages. For example, the UEs 105 can be configured to use the first option for beam management configuration messages and the second option for beam reporting request messages.

In some implementations, the UEs 105 are configured with one or more options for selecting the beams for Rx UE-Tx UE messages in an initial beam pairing procedure. The Rx UE-Tx UE messages in an initial beam pairing procedure include a beam management configuration message, a beam pairing request message, a beam reporting message, and a beam indication message. In a first option, the UEs 105 are configured to select an omni-directional Tx beam and an omni-directional Rx beam.

In a second option, the UEs 105 are configured to use a specific Tx beam and a specific Rx beam. In this option, the beam pair can be configured in a beam management configuration message or by resource pool (pre)configuration. The beam pair may be associated with the beam pair from the Tx UE to the Rx UE. For example, the beam pair for the Rx UE-Tx UE messages may be a corresponding beam pair to the beam pair for Tx UE-Rx UE messages. For instance, if the beam pair for the Tx UE-Rx UE messages is (T1, R1), then the beam pair for the Rx UE-Tx UE messages is (T2, R2), where T1 is equal to R2 and R1 is equal to T2.

In a third option, the Rx UE is configured to use multiple Tx beams in different directions. These Tx beams may be configured in a beam management configuration message or by resource pool (pre)configuration. In this option, the Rx beam is based on the Tx UE's implementation (e.g., a specific Rx beam or an omni-directional Rx beam). In some examples, the UEs 105 are configured to use different options for different Rx UE-Tx UE messages.

In some implementations, the UEs 105 are configured with one or more options for selecting the beams for Tx UE-Rx UE messages in a beam maintenance procedure. The Tx UE-Rx UE messages in a beam maintenance procedure include a beam maintenance request message and a beam switching indication message. Prior to implementing a beam maintenance procedure, a Tx UE has an existing serving Tx beam (T1), and an Rx UE has existing serving Rx beam (R1). One of the UEs then transmits a beam maintenance request message to start the beam maintenance procedure. If the Tx UE is sending the beam maintenance request message, then the Rx UE needs to select an Rx beam for receiving the message. During the beam maintenance procedure, the Tx UE sends CSI-RS via different Tx beams (e.g., T2, T3, T4). By measuring the CSI-RS, the Rx UE determines that T2 is the best Tx beam and determines that the corresponding Rx beam is R2. For example, the Rx UE can determine that the beam pair (T2, R2) has the greatest RSRP compared to other beam pairs, e.g., (T2, R3), (T2, R4), (T3, R2), (T3, R3), etc. Then, the Rx UE reports to the Tx UE an indication of Tx beam T2 in its beam reporting message. After sending the beam reporting message, the Rx UE needs to select an Rx beam to receive the beam switching indication message from the Tx UE.

In some examples, the UEs 105 are configured with one or more options for selecting beams for a beam maintenance request message and one or more options for selecting beams for a beam switching indication message. In a first option for the beam maintenance request message, the UEs 105 are configured to use the existing serving Tx beam and the existing serving Rx beam, e.g., the existing beams for data transmission from the Tx UE to the Rx UE. In a second option for the beam maintenance request message, the UEs 105 are configured to use a specific Tx beam and a specific Rx beam. In this option, the beam pair can be configured in a beam management configuration message or by resource pool (pre)configuration.

In a first option for the beam switching indication message, the UEs 105 are configured to use an existing serving Tx beam and an existing serving Rx beam. In a second option for the beam maintenance request message, the UEs 105 are configured to use a new Tx beam indicated in the beam switching indication message. In this option, the UEs 105 can be configured to use a new Rx beam that corresponds to the new Tx beam. For instance, in the example where the beam pair (T2, R2) has the greatest RSRP (i.e., the new Tx beam is T2), the Rx UE selects R2 as the Rx beam. In a third option for the beam switching indication message, the UEs 105 are configured to use a specific Tx beam and a specific Rx beam. In this option, the beam pair can be configured in a beam management configuration message or resource pool (pre)configuration.

In some implementations, the UEs 105 are configured with one or more options for selecting the beams for Rx UE-Tx UE messages in a beam maintenance procedure. The Rx UE-Tx UE messages in a beam maintenance procedure include (i) a beam maintenance request message and (ii) a beam reporting and beam switching indication message. In some examples, the UEs 105 are configured with one or more options for selecting beams for a beam maintenance request message and one or more options for selecting beams for a beam reporting and beam switching indication message.

In a first option for the beam maintenance request message, the UEs 105 are configured to use an existing serving Tx beam and an existing serving Rx beam, e.g., the existing beams for data transmission from the Rx UE to the Tx UE. This beam pair may be associated with the serving beam pair from the Tx UE to the Rx UE. For example, if the serving beam pair for the Tx UE to the Rx UE is (T1, R1), then the beam pair for the Rx UE to the Tx UE is (T2, R2), where T2 is equal to R1 and R2 is equal to T1. In a second option for the beam maintenance request message, the UEs 105 are configured to use a specific Tx beam and a specific Rx beam. In this option, the beam pair can be configured in a beam management configuration message or by resource pool (pre)configuration.

In a first option for the beam reporting and beam switching indication message, the UEs 105 are configured to use an existing serving Tx beam and an existing serving Rx beam, e.g., the existing beams for data transmission from the Rx UE to the Tx UE. In a second option, this beam pair may be associated with the serving beam pair from the Tx UE to the Rx UE. For example, if the serving beam pair for the Tx UE to the Rx UE is (T1, R1), then the beam pair for the Rx UE to the Tx UE is (T2, R2), where T2 is equal to R1 and R2 is equal to T1. In a third option for the beam reporting and beam switching indication message, the UEs 105 are configured to use a specific Tx beam and a specific Rx beam. In this option, the beam pair can be configured in a beam management configuration message or by resource pool (pre)configuration. In a fourth option for the beam reporting and beam switching indication message, the UEs 105 are configured to use a new Tx beam corresponding to the beam indicated in the beam switching indication message or the beam reporting message.

In some implementations, the UEs 105 are configured with a sidelink beam refinement procedure. In this procedure, a first UE of the UEs 105 is configured to provide a second UE with an indication of the beam switching time of the first UE. In one implementation, an Rx UE provides its capability to a Tx UE in a sidelink Rx beam refinement procedure. Although the following description describes this implementation, the description can also be adapted to a sidelink Tx beam refinement procedure in which the Tx UE provides its capability to the Rx UE.

In some implementations, the Rx UE provides the Rx beam switching time as a number of beam-switching operations that the Rx UE can perform in a slot. The number of beam-switching operations can depend on a subcarrier spacing (SCS) of the channel on which the beam is operating. Here, the larger the SCS, the fewer the number of beam-switching operations that an Rx UE can perform in a slot. In some examples, the Rx UE can provide the beam switching time in a beamswitchTiming message and can provide the number of beam-switching operations in a maxNumberRxTxBeamSwitchDL message.

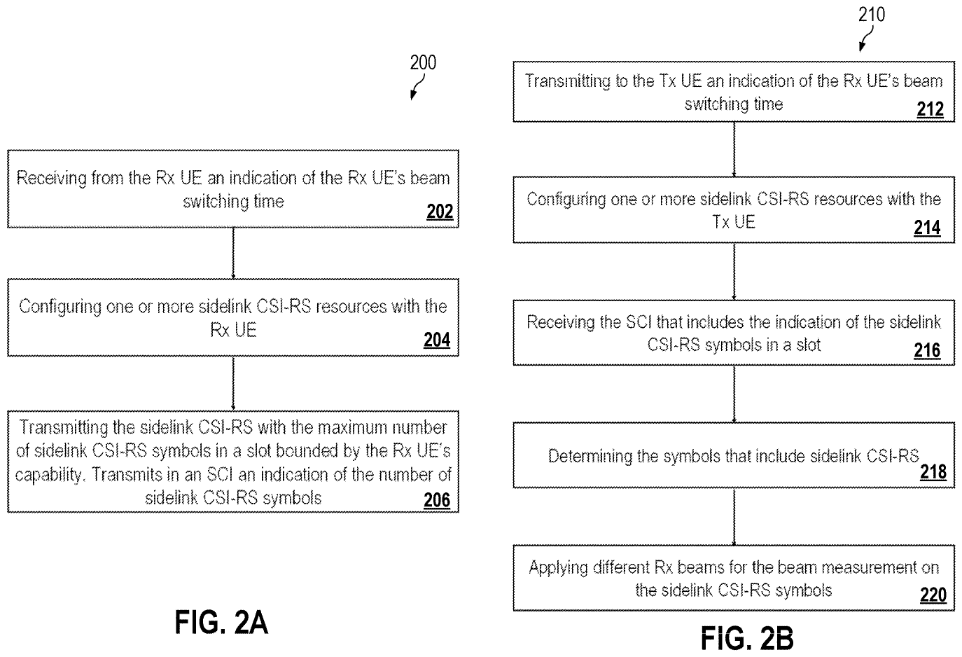

FIG. 2A and FIG. 2B illustrate a sidelink Rx beam refinement procedure, according to some implementations. FIG. 2A illustrates a Tx UE procedure 200 in the sidelink Rx beam refinement procedure. And FIG. 2B illustrates an Rx UE procedure 210 in the sidelink Rx beam refinement procedure.

Starting with the Tx UE procedure 200, at step 202, the Tx UE receives from the Rx UE an indication of the Rx UE's beam switching time. In one example, the indication is the Rx UE's capability of a number of beam-switching operations in a slot. The indication can be sent in a beamswitchTiming message and/or a maxNumberRxTxBeamSwitchDL message. At step 204, the Tx UE configures one or more sidelink CSI-RS resources with the Rx UE. At step 206, the Tx UE transmits sidelink CSI-RS, where the number of CSI-RS symbols in the slot is bound by the Rx UE's capability. Additionally, the Tx UE includes in an SCI an indication of the number of sidelink CSI-RS symbols. More specifically, the Tx UE can include in the SCI (either stage 1 or stage 2) the number of sidelink CSI-RS symbols in the current transmission and/or an indication of the sidelink CSI-RS resource index. The CSI-RS resource index indicates which configured CSI-RS resource is used. The CSI-RS resource configuration includes the beam direction of CSI-RS, the time and frequency location of CSI-RS, etc. Note that the number of sidelink CSI-RS symbols is less than or equal to the Rx UE's capability of number of beam-switching in a slot. If the number is greater than 1, then the sidelink CSI-RS repetition is implicitly “ON.”

Turning to the Rx UE procedure 210, at step 212, the Rx UE transmits to the Tx UE an indication of the Rx UE's beam switching time. At step 214, the Rx UE configures one or more sidelink CSI-RS resources with the Tx UE. At step 216, the Rx UE receives the SCI that includes the indication of the sidelink CSI-RS symbols in a slot. The Rx UE can determine the locations of sidelink CSI-RS symbols based on the number of sidelink CSI-RS symbols, following certain configured rules. For example, if there are three sidelink CSI-RS symbols, then the Rx UE can determine that the sidelink CSI-RS symbols are located at symbol locations #7, #10, #13. In the slot, there is a minimum gap between the last symbol of PSCCH or PSSCH and the sidelink CSI-RS symbols so that the SCI can be processed/decoded so that the Rx UE can determine how many sidelink CSI-RS symbols exist in the slot. At step 218, the Rx UE determines the symbols that include sidelink CSI-RS. At step 220, the Rx UE applies different Rx beams for the beam measurement on the sidelink CSI-RS symbols.

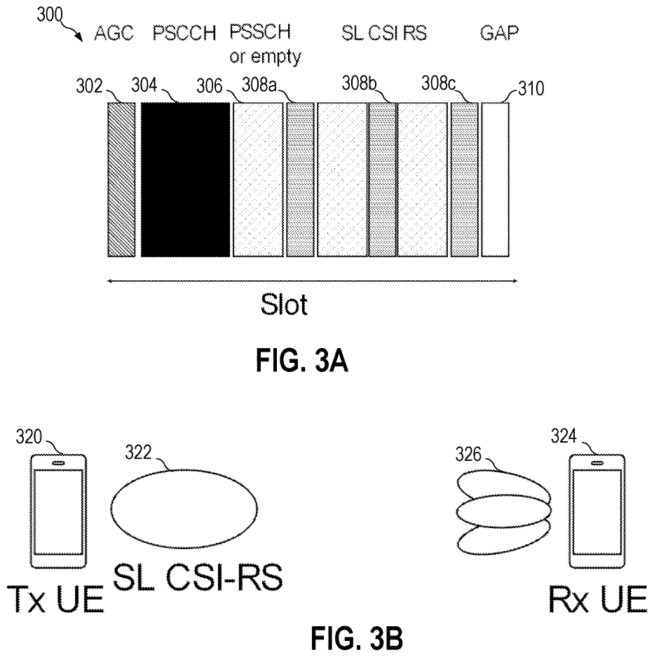

FIG. 3A and FIG. 3B illustrate an example Rx sidelink beam refinement procedure, according to some implementations. In this procedure, an Rx UE 324 transmits to a Tx UE 320 an indication of the Rx UE's beam switching time. In this example scenario, the Rx UE 324 transmits an indication that the Rx UE 324 can perform a maximum of four beam switching operations in the slot. Once the Tx UE 320 receives the indication, the Tx UE 320 selects a number of symbols for CSI-RS bound by the maximum number of switching operations that can be performed by the Rx UE 324. In this example, the Tx UE 320 selects three symbols.

FIG. 3A illustrates an example slot 300 in this scenario. As shown in FIG. 3A, the slot 300 includes an adaptive gain control (AGC) 302, a PSCCH 304, a PSSCH or gap 306, three slots 308a, 308b, 308c, and a gap 310. FIG. 3B illustrates transmission of CSI-RS in this scenario. As shown in FIG. 3B, the Tx UE 320 transmits a sidelink CSI-RS 322. The Rx UE 324 receives the sidelink CSI-RS 322 on the three symbols by switching between three beams 326 to receive CSI-RS using one beam in each symbol.

In some implementations, the UEs 105 are configured with one or more procedures for sidelink Rx beam determination. These procedures enable an Rx UE to select an appropriate Rx beam in various scenarios. As an example, the procedures can be used in scenarios where an Rx UE has established a plurality of Rx beams with a plurality of other UEs, perhaps to select an Rx beam when there is conflict between the plurality of Rx beams or when there are a plurality of Rx beams available for use.

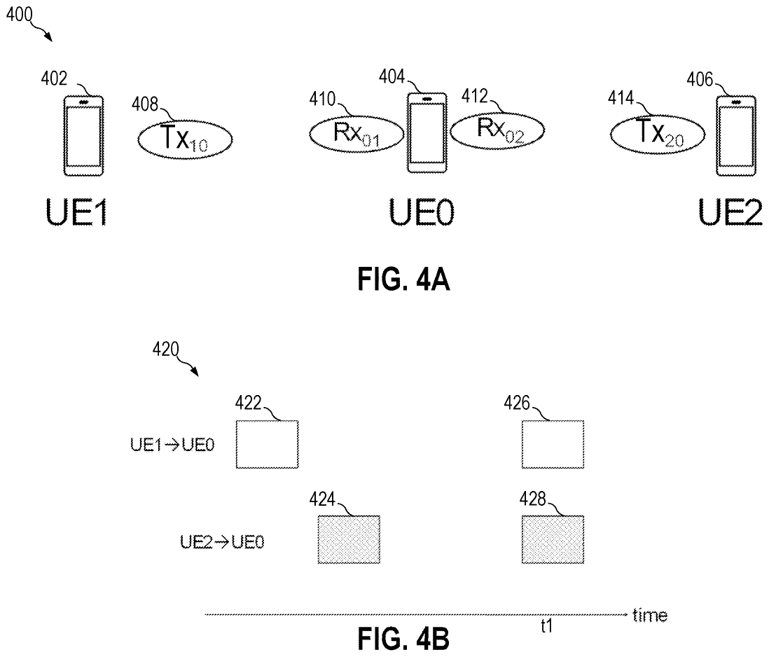

FIG. 4A illustrates an example scenario 400 for applying sidelink Rx beam determination procedures, according to some implementations. In the scenario 400, an Rx UE 404 (also called UE0) is operating as an Rx UE. The Rx UE 404 receives communications via Rx beams 410, 412 from UEs 402, 406, respectively. The UEs 402, 406 transmit communications to the UE 404 via beams 408, 414, respectively.

In some implementations, the Rx beam that the Rx UE selects can depend on the reception scenario. A first reception scenario involves a slot with data reception on a single beam. In this scenario, the Rx UE is configured to use an Rx beam associated with the paired Tx beam from the Tx UE. A second reception scenario involves a slot with data reception on more than one Rx beam. In this scenario, the Rx UE is configured to use one of two options for selecting the Rx beam for that slot. In a first option, the Rx UE is configured to use the Rx beam for the data transmission that has the highest priority. To illustrate using the example of FIG. 4A, if UE1's data priority is higher than UE2's data priority, then UE0 applies beam 410. Otherwise, UE0 applies beam 412. In a second option, the Rx UE is configured to use its own implementation to determine the Rx beam.

A third reception scenario involves a slot with a single beam measurement. In this scenario, on the symbols without sidelink CSI-RS, the Rx UE is configured to apply the same Rx beam as for normal sidelink data reception. And on the symbols with sidelink CSI-RS, the Rx UE is configured to apply the scheduled Rx beam for beam measurement.

A fourth reception scenario involves a slot with both beam measurement and data reception on different Rx beams. This scenario is illustrated in FIG. 4B as scenario 420. As shown in FIG. 4B, at time t1 both UE1 and UE2 are transmitting respective signals, e.g., CSI-RS and data, to UE0. In this scenario, the Rx UE is configured to use one of a plurality of options for selecting the Rx beam for that slot. In a first option, the Rx UE is configured to always use the scheduled Rx beam for beam measurement. In a second option, the Rx UE is configured to always use the scheduled Rx beam for data reception. In a third option, the Rx UE is configured to use resource pool (pre)configuration to select between the first option and the second option. In a fourth option, the Rx UE is configured to select the Rx UE depending on a priority of data reception. In particular, if the data priority is greater than a threshold, then the Rx UE is configured to use the Rx beam for data reception. Otherwise, the Rx UE is configured to use the Rx beam for beam measurement. In some examples, the threshold is (pre)configured per resource pool or PC5-RRC configured.

In fifth scenario, the Rx UE does not have a scheduled data reception or a beam measurement. In this scenario, the Rx UE is configured to use one of one or more options. In a first option, the Rx UE uses an omni-directional beam. In a second option, the Rx UE is configured to use specific beam as (pre)configured per resource pool or PC5-RRC.

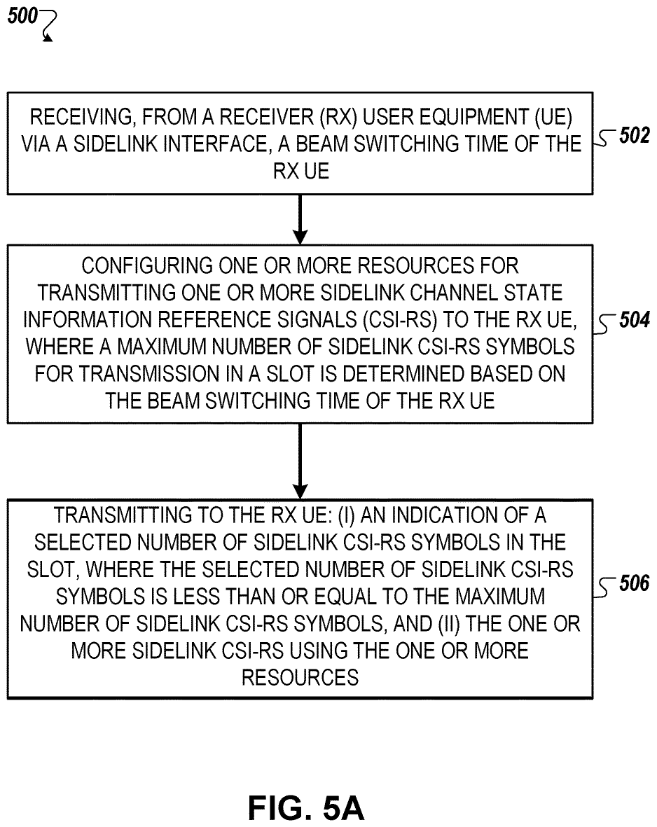

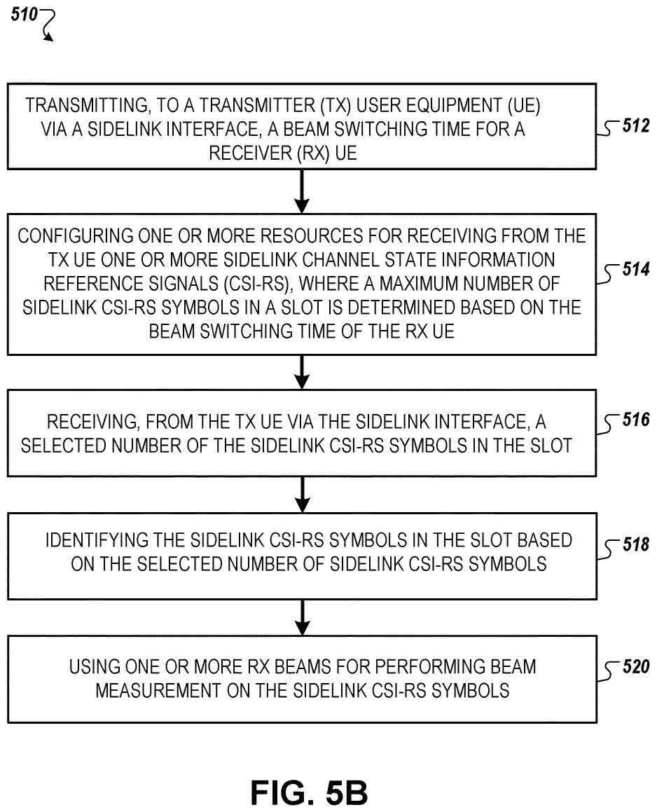

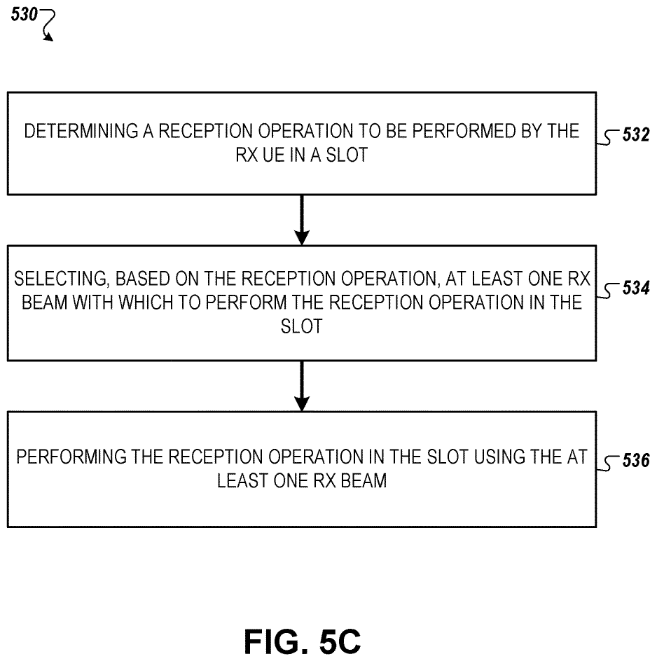

FIG. 5A illustrates a flowchart of an example method 500, according to some implementations. For clarity of presentation, the description that follows generally describes method 500 in the context of the other figures in this description. For example, method 500 can be performed by UEs 105 of FIG. 1. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order. In some examples, method 500 is performed by a transmitter (Tx) UE.

At step 502, method 500 involves receiving, from a receiver (Rx) user equipment (UE) via a sidelink interface, a beam switching time of the Rx UE.

At step 504, method 500 involves configuring one or more resources for transmitting one or more sidelink channel state information reference signals (CSI-RS) to the Rx UE, where a maximum number of sidelink CSI-RS symbols for transmission in a slot is determined based on the beam switching time of the Rx UE.

At step 506, method 500 involves transmitting to the Rx UE: (i) an indication of a selected number of sidelink CSI-RS symbols in the slot, where the selected number of sidelink CSI-RS symbols is less than or equal to the maximum number of sidelink CSI-RS symbols, and (ii) the one or more sidelink CSI-RS using the one or more resources.

In some implementations, the beam switching time of the Rx UE is a number of beam-switching operations that the Rx UE is capable of performing in the slot.

In some implementations, the number of beam-switching operations is based on a subcarrier spacing (SCS) of the sidelink interface.

In some implementations, transmitting to the Rx UE the actual number of sidelink CSI-RS symbols in the slot involves transmitting the actual number of sidelink CSI-RS symbols in a sidelink control information (SCI) message.

In some implementations, the SCI message further includes a resource index of the one or more sidelink CSI-RS.

In some implementations, the actual number of sidelink CSI-RS symbols in the slot is less than or equal to the maximum number of sidelink CSI-RS symbols.

In some implementations, a location of the sidelink CSI-RS symbols in the slot is determined based on the actual number of sidelink CSI-RS symbols.

In some implementations, the slot further includes one or more Physical Sidelink Control Channel (PSCCH) symbols preceding the sidelink CSI-RS symbols.

In some implementations, the slot further includes a minimum gap between a last symbol of PSCCH and a first sidelink CSI-RS symbol.

FIG. 5B illustrates a flowchart of an example method 510, according to some implementations. For clarity of presentation, the description that follows generally describes method 510 in the context of the other figures in this description. For example, method 510 can be performed by UEs 105 of FIG. 1. It will be understood that method 510 can be performed, for example, by any suitable system, environment, software, hardware, or a combination of systems, environments, software, and hardware, as appropriate. In some implementations, various steps of method 510 can be run in parallel, in combination, in loops, or in any order. In some examples, method 510 is performed by a receiver (Rx) UE.

At step 512, method 510 involves transmitting, to a transmitter (Tx) user equipment (UE) via a sidelink interface, a beam switching time for a receiver (Rx) UE.

At step 514, method 510 involves configuring one or more resources for receiving from the Tx UE one or more sidelink channel state information reference signals (CSI-RS), where a maximum number of sidelink CSI-RS symbols in a slot is determined based on the beam switching time of the Rx UE.

At step 516, method 510 involves receiving, from the Tx UE via the sidelink interface, a selected number of the sidelink CSI-RS symbols in the slot.

At step 518, method 510 involves identifying the sidelink CSI-RS symbols in the slot based on the selected number of sidelink CSI-RS symbols.

At step 520, method 510 involves using one or more Rx beams for performing beam measurement on the sidelink CSI-RS symbols.

In some implementations, the beam switching time of the Rx UE is a number of beam-switching operations that the Rx UE is capable of performing in the slot.

In some implementations, the number of beam-switching operations is based on a subcarrier spacing (SCS) of the sidelink interface.

In some implementations, receiving, from the Tx UE via the sidelink interface, the actual number of the sidelink CSI-RS symbols in the slot involves receiving the actual number of sidelink CSI-RS symbols in a sidelink control information (SCI) message.

In some implementations, the SCI message further includes a resource index of the one or more sidelink CSI-RS.

In some implementations, identifying the sidelink CSI-RS symbols in the slot is based on the resource index of the one or more sidelink CSI-RS.

In some implementations, the actual number of sidelink CSI-RS symbols in the slot is less than or equal to the maximum number of sidelink CSI-RS symbols.

In some implementations, identifying the sidelink CSI-RS symbols involves determining a location of the sidelink CSI-RS symbols in the slot based on the actual number of sidelink CSI-RS symbols.

In some implementations, the slot further includes one or more Physical Sidelink Control Channel (PSCCH) symbols preceding the sidelink CSI-RS symbols.

In some implementations, the slot further includes a minimum gap between a last symbol of PSCCH and a first sidelink CSI-RS symbol.

FIG. 5C illustrates a flowchart of an example method 530, according to some implementations. For clarity of presentation, the description that follows generally describes method 530 in the context of the other figures in this description. For example, method 530 can be performed by UEs 105 of FIG. 1. It will be understood that method 530 can be performed, for example, by any suitable system, environment, software, hardware, or a combination of systems, environments, software, and hardware, as appropriate. In some implementations, various steps of method 530 can be run in parallel, in combination, in loops, or in any order. In some examples, method 530 is performed by a receiver (Rx) user equipment (UE) that communicates with one or more transmitter (Tx) UEs on a sidelink interface via one or more Rx beams.

At step 532, method 530 involves determining a reception operation to be performed by the Rx UE in a slot.

At step 534, method 530 involves selecting, based on the reception operation, at least one Rx beam with which to perform the reception operation in the slot.

At step 536, method 530 involves performing the reception operation in the slot using the at least one Rx beam.

In some implementations, determining the reception operation to be performed by the Rx UE in the slot involves determining that the reception operation is data reception from a first Tx UE.

In some implementations, selecting, based on the reception operation, at least one Rx beam with which to perform the reception operation in the slot involves selecting a first Rx beam that is associated with Tx beam between the Rx UE and the first Tx UE.

In some implementations, determining the reception operation to be performed by the Rx UE in the slot involves determining that the reception operation is respective data reception from a first Tx UE and a second Tx UE.

In some implementations, selecting, based on the reception operation, at least one Rx beam with which to perform the reception operation in the slot involves determining that the respective data reception from the first Tx UE has a higher priority than the respective data reception from the second Tx UE; and responsively selecting a first Rx beam between the Rx UE and the first Tx UE for performing the respective data reception from the first Tx UE.

In some implementations, determining the reception operation to be performed by the Rx UE in the slot involves determining that the reception operation is measurement of a beam measurement signal from a first Tx UE.

In some implementations, selecting, based on the reception operation, at least one Rx beam with which to perform the reception operation in the slot involves for one or more symbols in the slot that do not include the beam measurement signal, selecting a first Rx beam that is associated with Tx beam between the Rx UE and the first Tx UE; and for one or more symbols in the slot that include the beam measurement signal, selecting one or more scheduled Rx beams for the measurement.

In some implementations, determining the reception operation to be performed by the Rx UE in the slot involves determining that the reception operation comprises measurement of a beam measurement signal from a first Tx UE and data reception from a second Tx UE.

In some implementations, selecting, based on the reception operation, at least one Rx beam with which to perform the reception operation in the slot involves selecting a first scheduled Rx beam for the measurement; or selecting a second scheduled Rx beam for data reception.

In some implementations, selecting between the first scheduled Rx beam and the second scheduled Rx beam is based on a resource pool configuration or pre-configuration, or a priority of the data reception.

In some implementations, determining the reception operation to be performed by the Rx UE in the slot involves determining that the reception operation comprises a sensing operation.

In some implementations, selecting, based on the reception operation, at least one Rx beam with which to perform the reception operation in the slot involves selecting an omni-directional Rx beam; or selecting a preconfigured Rx beam.

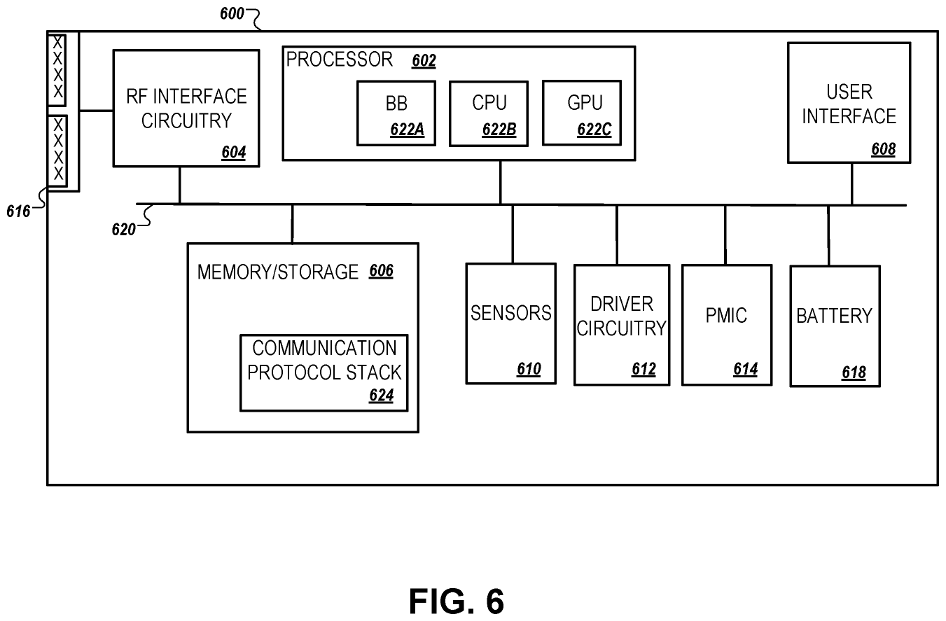

FIG. 6 illustrates an example UE 600, according to some implementations. The UE 600 may be similar to and substantially interchangeable with UEs 105 of FIG. 1.

The UE 600 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 600 may include processor 602, RF interface circuitry 604, memory/storage 606, user interface 608, sensors 610, driver circuitry 612, power management integrated circuit (PMIC) 614, one or more antenna(s) 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processor 602 may include one or more processors. For example, the processor 602 may include processor circuitry such as, for example, baseband processor circuitry (BB) 622A, central processor unit circuitry (CPU) 622B, and/or graphics processor unit circuitry (GPU) 622C. The processor 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

In some implementations, processor 602 is configured to perform operations including: receiving, from a receiver (Rx) user equipment (UE) via a sidelink interface, a beam switching time of the Rx UE; configuring one or more resources for transmitting one or more sidelink channel state information reference signals (CSI-RS) to the Rx UE, where a maximum number of sidelink CSI-RS symbols for transmission in a slot is determined based on the beam switching time of the Rx UE; and causing transmission to the Rx UE: of (i) an indication of a selected number of sidelink CSI-RS symbols in the slot, where the selected number of sidelink CSI-RS symbols is less than or equal to the maximum number of sidelink CSI-RS symbols, and (ii) the one or more sidelink CSI-RS using the one or more resources.

In some implementations, processor 602 is configured to perform operations including causing transmission, to a transmitter (Tx) user equipment (UE) via a sidelink interface, of a beam switching time for a receiver (Rx) UE; configuring one or more resources for receiving from the Tx UE one or more sidelink channel state information reference signals (CSI-RS), wherein a maximum number of sidelink CSI-RS symbols in a slot is determined based on the beam switching time of the Rx UE; receiving, from the Tx UE via the sidelink interface, a selected number of the sidelink CSI-RS symbols in the slot; identifying the sidelink CSI-RS symbols in the slot based on the selected number of sidelink CSI-RS symbols; and using one or more Rx beams for performing beam measurement on the sidelink CSI-RS symbols.

In some implementations, processor 602 is configured to perform operations including determining a reception operation to be performed by the Rx UE in a slot; selecting, based on the reception operation, at least one Rx beam with which to perform the reception operation in the slot; and performing the reception operation in the slot using the at least one Rx beam.

The memory/storage 606 may include one or more non-transitory, computer-readable media that includes instructions (for example, communication protocol stack 624) that may be executed by the processor 602 to cause the UE 600 to perform various operations described herein. The memory/storage 606 include any type of volatile or non-volatile memory that may be distributed throughout the UE 600. In some implementations, some of the memory/storage 606 may be located on the processor 602 itself (for example, L1 and L2 cache), while other memory/storage 606 is external to the processor 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 616 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 616. In various implementations, the RF interface circuitry 604 may be configured to transmit/receive signals in a manner compatible with NR access technologies.

The antenna(s) 616 may include one or more antenna elements to convert electrical signals into radio waves to travel through the air and to convert received radio waves into electrical signals. The antenna elements may be arranged into one or more antenna panels. The antenna(s) 616 may have antenna panels that are omnidirectional, directional, or a combination thereof to enable beamforming and multiple input, multiple output communications. The antenna(s) 616 may include microstrip antennas, printed antennas fabricated on the surface of one or more printed circuit boards, patch antennas, phased array antennas, etc. The antenna(s) 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensors 610 and control and allow access to sensors 610, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processor 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted or deployed in a fixed location, and may have a power supply coupled to an electrical grid. The battery 618 may be a lithium-ion battery, a metal-air battery, such as a zinc-air battery, an aluminum-air battery, a lithium-air battery, and the like. In some implementations, such as in vehicle-based applications, the battery 618 may be a typical lead-acid automotive battery.

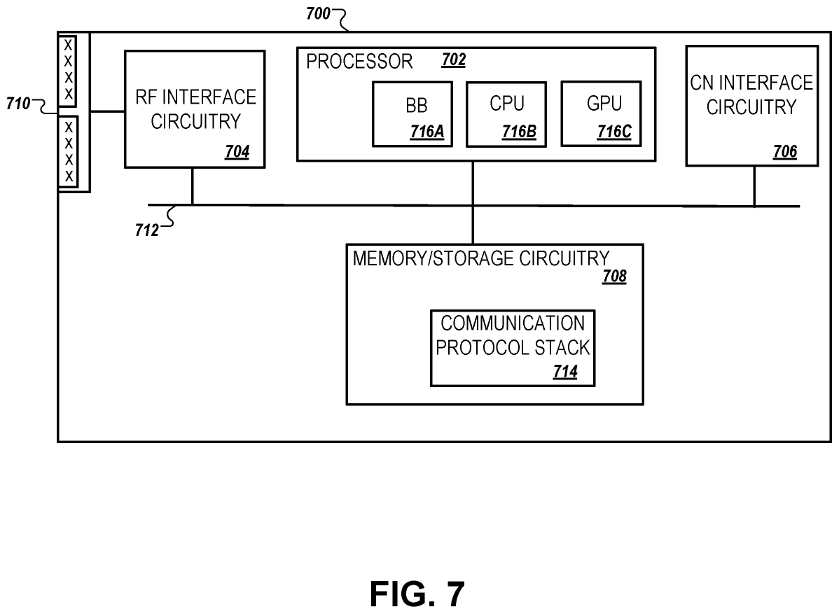

FIG. 7 illustrates an example access node 700 (e.g., a base station or gNB), according to some implementations. The access node 700 may be similar to and substantially interchangeable with base stations 110. The access node 700 may include processor 702, RF interface circuitry 704, core network (CN) interface circuitry 706, memory/storage circuitry 708, and one or more antenna(s) 710.

The components of the access node 700 may be coupled with various other components over one or more interconnects 712. The processor 702, RF interface circuitry 704, memory/storage circuitry 708 (including communication protocol stack 714), antenna(s) 710, and interconnects 712 may be similar to like-named elements shown and described with respect to FIG. 6. For example, the processor 702 may include processor circuitry such as, for example, baseband processor circuitry (BB) 716A, central processor unit circuitry (CPU) 716B, and/or graphics processor unit circuitry (GPU) 716C. The processor 702 may include any type of circuitry or processor circuitry that executes or otherwise operates computer-executable instructions, such as program code, software modules, or functional processes from memory/storage circuitry 708 to cause the access node 700 to perform operations as described herein.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. As another example, circuitry associated with a UE, base station, network element, etc. as described above in connection with one or more of the preceding figures may be configured to operate in accordance with one or more of the examples set forth below in the example section.

Example 1 includes one or more processors configured to perform operations including: receiving, from a receiver (Rx) user equipment (UE) via a sidelink interface, a beam switching time of the Rx UE; configuring one or more resources for transmitting one or more sidelink channel state information reference signals (CSI-RS) to the Rx UE, where a maximum number of sidelink CSI-RS symbols for transmission in a slot is determined based on the beam switching time of the Rx UE; and causing transmission to the Rx UE: of (i) an indication of a selected number of sidelink CSI-RS symbols in the slot, where the selected number of sidelink CSI-RS symbols is less than or equal to the maximum number of sidelink CSI-RS symbols, and (ii) the one or more sidelink CSI-RS using the one or more resources.

Example 2 includes the one or more processors of Example 1, where the beam switching time of the Rx UE is a number of beam switching operations that the Rx UE is capable of performing in the slot.

Example 3 includes the one or more processors of Example 2, where the number of beam switching operations is based on a subcarrier spacing (SCS) of the sidelink interface.

Example 4 includes the one or more processors of Example 1, where causing transmission to the Rx UE of the actual number of sidelink CSI-RS symbols in the slot includes: causing transmission of the actual number of sidelink CSI-RS symbols in a sidelink control information (SCI) message.

Example 5 includes the one or more processors of Example 4, where the SCI message further includes a resource index of the one or more sidelink CSI-RS.

Example 6 includes the one or more processors of Example 1, where a location of the sidelink CSI-RS symbols in the slot is determined based on the actual number of sidelink CSI-RS symbols.

Example 7 includes the one or more processors of Example 1, where the slot further includes one or more Physical Sidelink Control Channel (PSCCH) symbols preceding the sidelink CSI-RS symbols.

Example 8 includes the one or more processors of Example 7, where the slot further includes a minimum gap between a last symbol of PSCCH and a first sidelink CSI-RS symbol.

Example 9 includes one or more processors configured to perform operations including: causing transmission, to a transmitter (Tx) user equipment (UE) via a sidelink interface, of a beam switching time for a receiver (Rx) UE; configuring one or more resources for receiving from the Tx UE one or more sidelink channel state information reference signals (CSI-RS), wherein a maximum number of sidelink CSI-RS symbols in a slot is determined based on the beam switching time of the Rx UE; receiving, from the Tx UE via the sidelink interface, a selected number of the sidelink CSI-RS symbols in the slot; identifying the sidelink CSI-RS symbols in the slot based on the selected number of sidelink CSI-RS symbols; and using one or more Rx beams for performing beam measurement on the sidelink CSI-RS symbols.

Example 10 includes the one or more processors of Example 9, where the beam switching time of the Rx UE is a number of beam switching operations that the Rx UE is capable of performing in the slot.

Example 11 includes the one or more processors of Example 10, where the number of beam switching operations is based on a subcarrier spacing (SCS) of the sidelink interface.

Example 12 includes the one or more processors of Example 9, where receiving, from the Tx UE via the sidelink interface, the actual number of the sidelink CSI-RS symbols in the slot includes: receiving the actual number of sidelink CSI-RS symbols in a sidelink control information (SCI) message.

Example 13 includes the one or more processors of Example 12, where the SCI message further includes a resource index of the one or more sidelink CSI-RS.

Example 14 includes the one or more processors of Example 13, where identifying the sidelink CSI-RS symbols in the slot is based on the resource index of the one or more sidelink CSI-RS.

Example 15 includes the one or more processors of Example 9, where the actual number of sidelink CSI-RS symbols in the slot is less than or equal to the maximum number of sidelink CSI-RS symbols.

Example 16 includes the one or more processors of Example 9, where identifying the sidelink CSI-RS symbols includes: determining a location of the sidelink CSI-RS symbols in the slot based on the actual number of sidelink CSI-RS symbols.

Example 17 includes the one or more processors of Example 9, where the slot further includes one or more Physical Sidelink Control Channel (PSCCH) symbols preceding the sidelink CSI-RS symbols.

Example 18 includes the one or more processors of Example 17, where the slot further comprises a minimum gap between a last symbol of PSCCH and a first sidelink CSI-RS symbol.

Example 19 includes one or more processors of a receiver (Rx) user equipment (UE) that communicates with one or more transmitter (Tx) UEs on a sidelink interface via one or more Rx beams, the one or more processors configured to perform operations including: determining a reception operation to be performed by the Rx UE in a slot; selecting, based on the reception operation, at least one Rx beam with which to perform the reception operation in the slot; and performing the reception operation in the slot using the at least one Rx beam.

Example 20 includes the one or more processors of Example 19, where determining the reception operation to be performed by the Rx UE in the slot includes: determining that the reception operation is data reception from a first Tx UE.

Example 21 includes the one or more processors of Example 20, where selecting, based on the reception operation, at least one Rx beam with which to perform the reception operation in the slot includes: selecting a first Rx beam that is associated with Tx beam between the Rx UE and the first Tx UE.

Example 22 includes the one or more processors of Example 19, where determining the reception operation to be performed by the Rx UE in the slot includes: determining that the reception operation is respective data reception from a first Tx UE and a second Tx UE.

Example 23 includes the one or more processors of Example 22, where selecting, based on the reception operation, at least one Rx beam with which to perform the reception operation in the slot includes: determining that the respective data reception from the first Tx UE has a higher priority than the respective data reception from the second Tx UE; and responsively selecting a first Rx beam between the Rx UE and the first Tx UE for performing the respective data reception from the first Tx UE.

Example 24 includes the one or more processors of Example 19, where determining the reception operation to be performed by the Rx UE in the slot includes: determining that the reception operation is measurement of a beam measurement signal from a first Tx UE.

Example 25 includes the one or more processors of Example 24, where selecting, based on the reception operation, at least one Rx beam with which to perform the reception operation in the slot includes: for one or more symbols in the slot that do not include the beam measurement signal, selecting a first Rx beam that is associated with Tx beam between the Rx UE and the first Tx UE; and for one or more symbols in the slot that include the beam measurement signal, selecting one or more scheduled Rx beams for the measurement.

Example 26 includes the one or more processors of Example 19, where determining the reception operation to be performed by the Rx UE in the slot includes: determining that the reception operation includes measurement of a beam measurement signal from a first Tx UE and data reception from a second Tx UE.

Example 27 includes the one or more processors of Example 26, where selecting, based on the reception operation, at least one Rx beam with which to perform the reception operation in the slot includes: selecting a first scheduled Rx beam for the measurement; or selecting a second scheduled Rx beam for data reception.

Example 28 includes the one or more processors of Example 27, where selecting between the first scheduled Rx beam and the second scheduled Rx beam is based on: a resource pool configuration or pre-configuration; or a priority of the data reception.

Example 29 includes the one or more processors of Example 19, where determining the reception operation to be performed by the Rx UE in the slot includes: determining that the reception operation includes a sensing operation.

Example 30 includes the one or more processors of Example 29, where selecting, based on the reception operation, at least one Rx beam with which to perform the reception operation in the slot includes: selecting an omni-directional Rx beam; or selecting a preconfigured Rx beam.

Example 31 includes an apparatus including logic, modules, and/or circuitry (e.g., processing circuitry) to perform one or more elements of the operations described in or related to any of Examples 1-30, or any other method or process described herein.

Example 32 includes a method, technique, or process as described in or related to any of Examples 1-30, or portions or parts thereof.

Example 33 includes an apparatus including: one or more processors and one or more computer-readable media including instructions that, when executed by the one or more processors, cause the one or more processors to perform the operations, techniques, or process as described in or related to any of Examples 1-30, or portions thereof.

Example 34 includes a method of communicating in a wireless network as shown and described herein.

Example 35 includes a system for providing wireless communication as shown and described herein. The operations or actions performed by the system can include the operations of any one of Examples 1-30.

Example 36 includes a device for providing wireless communication as shown and described herein. The operations or actions performed by the device can include the operations of any one of Examples 1-30.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors configured to perform operations comprising:
receiving, from a receiver (Rx) user equipment (UE) via a sidelink interface, a beam switching time of the Rx UE;
configuring one or more resources for transmitting one or more sidelink channel state information reference signals (CSI-RS) to the Rx UE, wherein a maximum number of sidelink CSI-RS symbols for transmission in a slot is determined based on the beam switching time of the Rx UE; and
causing transmission to the Rx UE: of (i) an indication of a selected number of sidelink CSI-RS symbols in the slot, wherein the selected number of sidelink CSI-RS symbols is less than or equal to the maximum number of sidelink CSI-RS symbols, and (ii) the one or more sidelink CSI-RS using the one or more resources.

2. The one or more processors of claim 1, wherein the beam switching time of the Rx UE is a number of beam switching operations that the Rx UE is capable of performing in the slot.

3. The one or more processors of claim 2, wherein the number of beam switching operations is based on a subcarrier spacing (SCS) of the sidelink interface.

4. The one or more processors of claim 1, wherein causing transmission to the Rx UE of the indication of the selected number of sidelink CSI-RS symbols in the slot comprises:
causing transmission of the indication of the selected number of sidelink CSI-RS symbols in a sidelink control information (SCI) message.

5. The one or more processors of claim 4, wherein the SCI message further comprises a resource index of the one or more sidelink CSI-RS.

6. The one or more processors of claim 1, wherein a location of the sidelink CSI-RS symbols in the slot is determined based on the selected number of sidelink CSI-RS symbols.

7. The one or more processors of claim 1, wherein the slot further comprises one or more Physical Sidelink Control Channel (PSCCH) symbols preceding the sidelink CSI-RS symbols.

8. The one or more processors of claim 7, wherein the slot further comprises a minimum gap between a last symbol of the one or more PSCCH symbols and a first symbol of the sidelink CSI-RS symbols.

9.-18. (canceled)

19. One or more processors of a receiver (Rx) user equipment (UE) that communicates with one or more transmitter (Tx) UEs on a sidelink interface via one or more Rx beams, the one or more processors configured to perform operations comprising:
determining a reception operation to be performed by the Rx UE in a slot;
selecting, based on the reception operation, at least one Rx beam with which to perform the reception operation in the slot; and
performing the reception operation in the slot using the at least one Rx beam.

20. The one or more processors of claim 19, wherein determining the reception operation to be performed by the Rx UE in the slot comprises:
determining that the reception operation is data reception from a first Tx UE.

21. The one or more processors of claim 20, wherein selecting, based on the reception operation, at least one Rx beam with which to perform the reception operation in the slot comprises:
selecting a first Rx beam that is associated with Tx beam between the Rx UE and the first Tx UE.

22. The one or more processors of claim 19, wherein determining the reception operation to be performed by the Rx UE in the slot comprises:
determining that the reception operation is respective data reception from a first Tx UE and a second Tx UE.

23. The one or more processors of claim 22, wherein selecting, based on the reception operation, at least one Rx beam with which to perform the reception operation in the slot comprises:
determining that the respective data reception from the first Tx UE has a higher priority than the respective data reception from the second Tx UE; and
responsively selecting a first Rx beam between the Rx UE and the first Tx UE for performing the respective data reception from the first Tx UE.

24. The one or more processors of claim 19, wherein determining the reception operation to be performed by the Rx UE in the slot comprises:
determining that the reception operation is measurement of a beam measurement signal from a first Tx UE.

25. The one or more processors of claim 24, wherein selecting, based on the reception operation, at least one Rx beam with which to perform the reception operation in the slot comprises:
for one or more symbols in the slot that do not include the beam measurement signal, selecting a first Rx beam that is associated with Tx beam between the Rx UE and the first Tx UE; and
for one or more symbols in the slot that include the beam measurement signal, selecting one or more scheduled Rx beams for the measurement.

26. The one or more processors of claim 19, wherein determining the reception operation to be performed by the Rx UE in the slot comprises:
determining that the reception operation comprises measurement of a beam measurement signal from a first Tx UE and data reception from a second Tx UE.

27. The one or more processors of claim 26, wherein selecting, based on the reception operation, at least one Rx beam with which to perform the reception operation in the slot comprises:
selecting a first scheduled Rx beam for the measurement; or
selecting a second scheduled Rx beam for data reception, wherein selecting between the first scheduled Rx beam and the second scheduled Rx beam is based on:
a resource pool configuration or pre-configuration; or
a priority of the data reception.

28. (canceled)

29. The one or more processors of claim 19, wherein determining the reception operation to be performed by the Rx UE in the slot comprises:
determining that the reception operation comprises a sensing operation.

30. The one or more processors of claim 29, wherein selecting, based on the reception operation, at least one Rx beam with which to perform the reception operation in the slot comprises:
selecting an omni-directional Rx beam; or
selecting a preconfigured Rx beam.

31. (canceled)

32. A method comprising:
receiving, from a receiver (Rx) user equipment (UE) via a sidelink interface, a beam switching time of the Rx UE;
configuring one or more resources for transmitting one or more sidelink channel state information reference signals (CSI-RS) to the Rx UE, wherein a maximum number of sidelink CSI-RS symbols for transmission in a slot is determined based on the beam switching time of the Rx UE; and
causing transmission to the Rx UE: of (i) an indication of a selected number of sidelink CSI-RS symbols in the slot, wherein the selected number of sidelink CSI-RS symbols is less than or equal to the maximum number of sidelink CSI-RS symbols, and (ii) the one or more sidelink CSI-RS using the one or more resources.
